(19) United States
(12) Patent Application Publication
(10) Pub. No.: US 2025/0012171 A1
(43) Pub. Date: Jan. 9, 2025

(54) System And Method For Carrying Out Different Modalities Of Simultaneous Capture, Utilization And Storage Of CO2

(71) Applicant: PETRÓLEO BRASILEIRO S.A. - PETROBRAS, Rio de Janeiro (BR)

(72) Inventors: Edgard Poiate Junior, Rio de Janeiro (BR); Ricardo Ghidetti Mangas Caratino, Rio de Janeiro (BR)

(21) Appl. No.: 18/753,997

(22) Filed: Jun. 25, 2024

(30) Foreign Application Priority Data
Jul. 4, 2023 (BR) 10 2023 013403 3

(51) Int. Cl. E21B 41/00

(52) U.S. Cl. CPC E21B 41/0064; E21B 2200/20

(57) ABSTRACT

The present invention finds its field of application as a means of operational flexibility and enabling different simultaneous modalities for the capture, utilization and storage of CO₂ in an integrated manner through thermomechanical cycling in a cavern built in salt rock. More particularly, in regions close to oil fields where there is a layer of evaporite rock close to the same and suitable for the construction of a cavern in salt rock, for its use as a geological buffer (lung) for CO₂ and thus ensuring the Net Carbon Negative Oil during the enhanced oil recovery in the exploitation life of an oil reserve.

### RELATED APPLICATIONS

This application claims the benefit of Brazilian Patent Application Serial No. BR 10 2023 013403 3, filed Jul. 4, 2023, the entire contents of which are expressly incorporated by reference herein.

### FIELD OF THE INVENTION

The present invention finds its field of application as a means of operational flexibility and enabling different simultaneous modalities for the capture, utilization and storage of CO₂ (CCUS-Carbon Capture, Utilization and Storage) in an integrated manner through cycling thermomechanical analysis in a cavern built on salt rock. More particularly, in regions close to oil fields where there is a layer of evaporite rock close to the same and suitable for the construction of a cavern in salt rock, for its use as a geological buffer (lung) for CO₂, sometimes filling, for accumulate excess CO₂ that should not be flowed into CO₂ injection wells (to maximize field recovery), sometimes emptying it to flow the CO₂ to other modalities of CCUS (such as depleted reservoir, aquifer, porous/permeable rock), thus maintaining always the optimal flow rate of CO₂ (in the exact amount of volume at a certain pressure) in CO₂ injection wells to maximize the hydrocarbon production from the oil field. Accordingly, the cavern acts as an intermediary or precursor, in a simultaneous and integrated way enabling other different CCUS modalities and thus ensuring Net Carbon Negative Oil during enhanced oil recovery in the useful life of exploitation of an oil reserve.

### BACKGROUND OF THE INVENTION

### Capture, Utilization and Storage of CO₂

According to the Intergovernmental Panel on Climate Change (IPCC), a United Nations body, global warming is mainly responsible for the anthropogenic emission of greenhouse gases (GHG) into the atmosphere.

The main consequences of global warming are the increase in the planet's average temperature, the rise in sea levels (due to the melting of polar ice caps) and the increase in the frequency of extreme weather events, such as tropical storms, floods, waves of heat, drought, blizzards, hurricanes, tornadoes and tsunamis, which have occurred in different regions of the planet. As a result, serious consequences are generated for populations and ecosystems, which could lead to the extinction of animal and plant species due to climate change.

One of the main human activities that emit large amounts of GHG that cause global warming and consequently climate change is the burning of fossil fuels (derived from oil, mineral coal and natural gas) to generate energy. And, among GHGs, carbon dioxide (CO₂) is the one with the greatest contribution, as it accounts for the highest percentage of emissions into the atmosphere.

One of the measures to reduce the effect of GHGs is through the energy transition to a low-carbon economy, naturally conditioned on the use of cleaner alternative energy sources (wind, solar, hydro). However, the speed of the energy transition can only be possible through (more conscious and more demanding) consumers of products with a low carbon footprint and, of course, with strong investments and government plans worldwide and, with companies generating products with lower emissions of GHG.

Another measure to reduce GHG is Carbon Capture, Utilization and Storage (CCUS). Generally, through this process, the captured CO₂ can be converted/mixed with other products/processes or stored in geological formations, in large volumes and safely for long periods.

As for the geological storage of CO₂, it can be carried out in certain reservoirs/rocks in solid form (in CO₂-reactive rock forming a mineral precipitate), in dissolution form (in saline aquifers or in oil and gas depleted reservoirs), adsorption (in mineral walls and pore throats), free-phase form (in structural or stratigraphic traps, such as salt rock) (IPCC, 2005. IPCC Special Report on Carbon Dioxide Capture and Storage. Prepared by Working Group III of the Intergovernmental Panel on Climate Change [METZ, B., O. DAVIDSON, H. C. de CONINCK, M. LOOS, and L. A. MEYER (eds.)]. Cambridge University Press, Cambridge, United Kingdom and New York, NY, USA, 2005, 442 p.).

Specifically, the geological storage of CO₂ in Cavern in Salt Rock (CSR) can have an excellent contribution in terms of volume of trapped CO₂ but, in terms of the safety of the process over time, the mineral trapping mechanism is superior (IPCC, 2005. IPCC Special Report on Carbon Dioxide Capture and Storage. Prepared by Working Group III of the Intergovernmental Panel on Climate Change [METZ, B., O. DAVIDSON, H. C. de CONINCK, M. LOOS, and L. A. MEYER (eds.)]. Cambridge University Press, Cambridge, United Kingdom and New York, NY, USA, 2005, 442 p.).

It is worth mentioning that due to its intrinsic characteristics such as negligible porosity and permeability and mechanical strength to compression similar to concrete, (POIATE Jr E. Mecânica das Rochas e Mecânica Computacional para Projeto de Poços de Petróleo em Zonas de Sal. Doctor of Science's Thesis, Pontifical Catholic University of Rio de Janeiro, PUC-Rio, December, 2012), make salt rock the ideal rock for storing various products, from compressed air (CROTOGINO F, MOHMEYER KU, SCHARF R. HUNTORF CAES: More than 20 Years of Successful Operation, Solution Mining Research Institute, Spring Meeting, Orlando, Florida, USA, 2001; SCHAINKER, R. B. Advanced Compressed Air Energy Storage (CAES) Demonstration Projects. EPRI Renewable Energy Council, 2011; VENKATARAMANI G, PARANKUSAM P, RAMALINGAM V, WANG J. A review on compressed air energy storage-A pathway for smartgrid and polygeneration. Renewable and Sustainable Energy Reviews, vol. 62, p 895-907, 2016.), crude oil (U. S. DEPARTMENT OF ENERGY, Strategic Petroleum Reserve Storage Sites. Available at: <http://www.fossil.energy.gov/programs/reserves/spr/sprsites.html>. Accessed on: Apr. 27, 2006a), natural gas (EVANS D J, CHADWICK R A (EDS). Underground gas storage: Worldwide experiences and future development in the UK and Europe. The Geological Society, London, Special Publication, 313, 93-128. 2009; SYLVIE C G. Underground gas storage in the world. France, Rueil Malmaison, CEDIGAZ. 2016.), hydrogen (LORD, A. S. Overview of geologic storage of natural gas with emphasis on assessing the feasibility of storing hydrogen. SAND2009-5878. Sandia National Laboratories. 2009; LORD, A. S., KOBOS, P. H., BORNS, D. J. Geological storage of hydrogen: Scaling up to meet city transportation demands. International Journal of Hydrogen Energy 39 (2014), p 11557-15582).

CSR also serves as a means of disposal for nuclear waste (MUNSON, D. E.; FOSSUM, A. F.; SENSENY, P. E. Approach to first principles model prediction of measured WIPP (Waste Isolation Pilot Plant) in-situ room closure in salt. Tunneling and Underground Space Technology, 5, 135, 1990; U.S. DEPARTMENT OF ENERGY. United States Department of Energy Carsbad Field Office. Available at: <http://www.wipp.energy.gov>. Accessed on: Apr. 27, 2006) and of drilling waste (VEIL J A, SMITH K P, TOMASKO D, ELCOCK D, BLUNT D, WILLIAMS G P. 1998. Disposal of NORM-contaminated oil field wastes in Salt Caverns. United States: N. p., 1998. Web. doi: 10.2172/808431). However, in this last modality, this only happens at the end of the CSR's useful life after 30 to 50 years operating as a storage medium. This maximizes the return on investment with CSR.

Accordingly, such characteristics allow a CSR to receive high injection and withdrawal rates of products (such as compressed air, crude oil, natural gas, nitrogen, hydrogen, etc.) in daily filling and emptying cycles, for years, to meet peaks in demand and supply and in emergency situations, which constitutes the main advantages of CSR in relation to other storage means. Furthermore, it requires a smaller volume of base gas (Cushing gas), compared to other alternatives, equivalent to around 20% of the burial gradient, which is the volume necessary to maintain adequate pressure to support the ceiling and walls of the CSR.

Specifically, regarding the use of CO₂ in the oil industry, CO₂ can be used as a means of supplementing the energy in the reservoir and enabling an increase in the recovery factor, which is called secondary and tertiary recovery or advanced recovery method, in English, Enhanced Oil Recovery (EOR).

EOR-CO₂ and EOR-Water Alternating Gas (WAG), both with CO₂ (Azfali, S., Rezaei, N., Zendehboudi, S. A comprehensive review on Enhanced Oil Recovery by Water Alternating Gas (WAG) Injection, Fuel 227:218-246, 2018) have been used successfully for decades and can be considered important forms of CCUS (GRIGG, R. B. SVEC, R. K, Injectivity changes and CO₂ Retention for EOR and Sequestration Projects, SPE/DOE Symposium on Improved Oil Recovery, USA, 2008; IEA, 2020. Energy Technology Perspectives 2020: Special Report on Carbon Capture Utilization and Storage—CCUS in clean energy transitions. Paris, France), for mitigating GHG emissions. And, according to the International Energy Agency (IEA), CCUS is the main technology to enable the continued use of fossil fuels by adding value to the business and contributing to the longevity of the oil industry (IEA, 2020. Energy Technology Perspectives 2020: Special Report on Carbon Capture Utilization and Storage—CCUS in clean energy transitions Paris, France).

### Enhanced Oil Recovery via CCUS

A hydrocarbon reservoir has a pressure associated with the fluids stored therein (primary energy) that can drive the flow of oil/gas from the rock formation to the surface, a scenario called production by natural elevation in a breakthrough well. The flow capacity of a well is given by the productivity index (IP), which depends on the relation between the oil flow rate under surface conditions and the static pressure differential of the reservoir and the flow pressure at the bottom of the well.

However, over the production time, depending on the intrinsic characteristics of the reservoir rock and the hydrocarbon, the pressure of the fluids, which tends to fall and thus the IP, is not adequate to overcome the resistance (loss of pressure) generated in the flow in the porous medium and in the production string to produce a volume of oil/gas that is technically viable (for the processes to function) and economically (THOMAS, J. E. et al. Fundamentos de engenharia de petróleo. Rio de Janeiro: ed. Interciência, 2004).

Therefore, it is necessary to apply artificial lifting and/or flow methods as an important alternative to mitigate problems occurring with the decline in reservoir pressure over production time, and even methods for increasing the reserve recovery factor, to maintain or increase its production flow rate to meet technical-economic requirements throughout the productive life of the well.

The methods that supplement energy in the reservoir and make it possible to increase the recovery factor are called secondary and tertiary recovery or advanced recovery, in English, Enhanced Oil Recovery (EOR) methods.

U.S. Pat. No. 2,623,596 discloses an EOR method by injecting CO₂ into the oil reservoir. And, US patent 35-5395 discloses the EOR method in which water must be injected alternately with a gas into the reservoir, in English, Alternate Gas and Water, which has recently been called alternating water and gas injection (WAG), in which the gas used in injection can be hydrocarbons from the reservoir or even CO₂.

The WAG method has advantages over the gas-only or water-only injection method, in highly heterogeneous reservoirs, regarding the efficiency of the volume swept in the reservoir; that is, in the production.

This happens because WAG injection delays the preferential paths of the gas, in English, fingering, through the injection of banks of more viscous fluids that would retain the gas inside the reservoir for longer. Thus, the gas having more contact time with the oil in the subsurface (in the reservoir) would be able to interact and incorporate the oil more effectively, reducing the viscosity of the oil, improving its mobility in the reservoir (GREEN, D. W. and WILLHITE G. P., 1998. Enhanced Oil Recovery, SPE Textbook Series, Volume 6. Society of Petroleum Engineers, Richardson, Texas).

WAG injection combines two predecessor methods (water injection or gas injection) and its function is to improve the reservoir sweep efficiency during gas injection. Generally, the injected gas is the gas itself (hydrocarbon) from the reservoir; therefore, the gas is reinjected into the reservoir to improve recovery efficiency and maintain reservoir pressure.

In the WAG method, the injection cycles consist of either a gas bank or a water bank. The injected gas has the function of mixing with the pre-existing fluid in the reservoir, thereby reducing its viscosity, decreasing its density, reducing the oil/water interfacial tension and increasing its mobility in the porous medium (microscopic effect). And, the water bank, injected next, has the function of pushing (macroscopic effect) the miscible oil bank formed by the gas bank, which would not have been produced under normal conditions, thus increasing the reservoir's recovery factor.

Furthermore, the WAG method makes it possible to delay the early breakthrough of injected gas, and control the increase in the Gas-Oil Ratio (GOR) in producing wells; otherwise, it could lead to a reduction in oil production due to the limitations in gas processing capacity in the Stationary Production Unit (SPU).

In a reservoir with the presence of CO₂, it could be used in the WAG process instead of reinjecting the gas (hydrocarbon) produced (QADIR S., Comparative study of FAWAG and SWAG as an effective EOR technique for a Malaysian field, 2012), as well as the CO₂ generated in the processes of a production unit (exhaust gases), thus reducing the effect of greenhouse gases released into the atmosphere.

In Brazil, the EOR-WAG process with CO₂-rich stream has been used in pre-salt fields (BELTRÃO, R. L. C.; SOMBRA, C. L.; LAGE, A. C. V. M.; FAGUNDES NETTO, J. R., HENRIQUES, C. C. D. Challenges and new technologies for the development of the pre-salt cluster, Santos Basin, Brazil. In: 2009 OFFSHORE TECHNOLOGY CONFERENCE, 2009; PIZARRO J. O. S., BRANCO, C. C. M. Challenges in Implementing an EOR Project in the Pre-Salt Province in Deep Offshore Brazil. In: SPE EOR Conference at Oil and Gas West Asia, Muscat, Oman, 2012), with the separation and treatment of CO₂ for reinjection being carried out by using technologies to increase the efficiency of treating gas produced in the Brazilian Pre-salt, such as, for example, means of developing new technologies in the area of membranes, in order to increase selectivity for CO₂, in English, Carbon Molecular Sieves (CMS) (TOUMA et al. Innovative Gas Treatment Solutions for Offshore Systems—Petrobras, OTC-29913-MS, OTC Brasil, October 2019; ANP, Estudo sobre o aproveitamento do gás natural do Pré-sal, 2020, Available at: http://www.anp.gov.br/arquivos/estudos/aproveitamento-gn-presal.pdf, accessed on 11/21/202).

Schaefer et al. (SCHAEFER, B. et al. 2017. Technical—Economic Evaluation of Continuous CO₂ Reinjection, Continuous Water Injection and Water Alternating Gas (Wag) Injection in Reservoirs Containing CO₂. XXXVIII Iberian Latin-American Congress on Computational Methods in Engineering (CILAMCE 2017). Florianópolis, S C, November 5-8, 10 2017) demonstrated by numerical simulation that WAG injection has an increase of 25% to 30% in the final recovery of a reservoir, compared to the continuous injection of water or gas alone, in a reservoir with characteristics of the Brazilian pre-salt.

And Lima et al. (LIMA et al. Journal of Petroleum Exploration and Production Technology (2020) 10:2947-2956. https://doi.org/10.1007/s13202-020-00968-4), also by numerical simulation demonstrated that the WAG injection (with CO₂) has a greater increase in the final recovery of a reservoir with characteristics of the Brazilian pre-salt when compared to the continuous injection of water or CO₂ alone.

According to the ANP, in the largest Pre-Salt reservoirs in operation (Lula, Sapinhoá, Búzios), the gas injection is carried out in the oil zone. The gas is injected alternately with water, with the aim of controlling the gas advance front and improving displacement and sweep efficiencies, increasing recovery. The more CO₂ there is in the injected gas stream, the easier it is to develop miscibility between gas and oil, since in reservoir conditions CO₂ tends to be an excellent solvent (ANP, Estudo sobre o aproveitamento do gás natural do Pré-sal, 2020 Available at: http://www.anp.gov.br/arquivos/estudos/aproveitamentogn-presal pdf, accessed on 11/21/202).

And, in the analyses for the various Pre-Salt fields, PPSA, based on studies carried out by operators, have observed that: when the reservoir does not present very significant depth differences, the reinjection of gas alternating with water (WAG), in a miscible process, provides the best results (ANP, Estudo sobre o aproveitamento do gas natural do Pré-sal, Available at: http://www.anp.gov.br/arquivos/estudos/aproveitamento-gn-presal.pdf, accessed on Nov. 21, 2020).

According to Lima, the general characteristics of pre-salt reservoirs, high pressure, low temperature and excellent quality of light oil are factors compatible with good miscibility between oil and gas (CO), are favorable for the application of the miscible WAG-CO₂ method (LIMA, T M. Foam assisted water alternating gas—FAWAG: um potencial método de recuperação avançada para aplicação no pré-sal brasileiro. Course Completion Work—Petroleum Engineering—CEP/CT/UFRN 2021.1, April 2021, NATAL, RN).

However, special attention must be paid, as CO₂ in contact with water forms carbonic acid, causing corrosion in the carbon steel materials in which it is flowed, and, if the boundary conditions in the reservoir have to be suitable for CO₂ injection, as well as the thermodynamic properties of the CO₂ oil mixture, in which its efficiency depends on whether it will be miscible in the oil.

Document BR 102015006079-3 B1, published on Jan. 9, 2018, refers to a hydrocarbon production integrated subsea system and a production method, which makes use of caverns opened by dissolution in salt rock, in which one cavern is for storing the liquid phase (oil and water) and another for storing gas, using a subsea separation system. The gas cavern would be used as a “logistical lung” to flow the gas through a gas pipeline to the continent and as storage for use on the logistic support platform, e the cavern with liquid (oil) can be coupled to a relief ship or an oil pipeline to export the oil to the continent. Therefore, it has the sole purpose of being a subsea production system, where operations that were carried out on the deck of a floating offshore platform or Stationary Production Unit (SPU) are now carried out underwater (Subsea Factory); in this way, it is possible to use smaller and lower-cost SPUs. Therefore, it only makes the primary separation of fluids (water, oil and gas) occur inside the cavern; there is no description regarding different CCUS modalities and how to enable the same; there is no description regarding enhanced oil recovery and how to apply the same.

Document BR 112014012285-7 B1, published on May 23, 2017, refers to a method for producing hydrocarbons. The method includes flowing a stream directly from a hydrocarbon reservoir into a cavern and performing a phase separation of the stream within the cavern to form an aqueous phase and an organic phase. The method also includes flowing at least a portion of the aqueous phase or the organic phase or both directly from the cavern to a subsurface location and discharging at least a portion of the organic phase from the cavern to a surface. That is, it describes the use of one to three caverns in salt rock as a gravitational separator (primary processing) of fluids (gas-water-oil), where oil is brought to the surface for monetization, while some amount of gas and water can be reinjected into the reservoir or aquifer. And, the cavern can also store the hydrocarbon until it is discharged. Therefore, there is no description regarding different modalities of CCUS and how to enable the same, and there is no description regarding the use of the cavern as an operational flexibility asset.

Document PI 1004503-1 B1, published on Aug. 14, 2012, refers to a system for developing one or more offshore hydrocarbon fields and method of receiving, processing and distributing a mixture of hydrocarbon collected from a hydrocarbon reservoir. The system basically comprises: (a) a floating hydrocarbon processing unit (separating oil, water and gas) moored on the seabed and connected to a hydrocarbon reservoir; (b) a temporary reservoir (depleted field or salt cavern) for storing the gas separated by (a); (c) a floating processing and liquefaction unit of the gas coming from (b); (d) a loading and unloading oil tanker that transports the oil separated by (a) to the shore; (e) an LNG loading and unloading tanker that transports the liquefied gas produced by (c) to the shore; (f) connecting tubes between (a), (b), (c), (d) and (e); (g) anchoring systems for (a) and (c). Therefore, there is no description regarding different CCUS modalities and how to enable the same; there is no description regarding enhanced oil recovery and how to apply the same; it is an economically unviable and hostile solution as it processes gases in deep LDA with an exclusive floating gas processing and liquefaction unit; there is no description regarding what is done with the other gases separated from natural gas.

The paper Technology readiness assessment of ultra-deep salt caverns for carbon capture and storage in Brazil. International Journal of Greenhouse Gas Control 99 (2020), presents a concept and describes a conceptual project called the Salt Cavern Hybrid Subsea Carbon Capture and Storage System (CCS), which refers to the gravitational separation of large volumes of natural gas (NG) of CO₂ inside a cavern in salt rock under high pressure. The concept basically comprises the following steps: (a) Construct one or more caverns in salt rocks by a leaching process in an offshore environment by applying submerged pumps using as raw materials seawater from the bottom of the sea, or by injecting seawater by the production platform itself; (b) Inject associated natural gas into a salt cavern until it is completely filled and reaches the maximum allowable pressure; (c) Close the upper part of the cavern and monitor the gravitational separation between NG and CO₂; (d) Extract the NG from the top of the cavern (to be monetized), and leave the supercritical CO₂ at the bottom of the cavern (for definitive storage). Therefore, there is no description regarding how to enable different CCUS modalities other than just using the cavern (filling the cavern and abandoning the same, just one cycle); there is no description regarding enhanced oil recovery and how to apply the same; and it is an economically unfeasible solution as it constructs a cavern in offshore salt rock, the costs of which are hundreds of thousands of dollars, to carry out just one cycle of filling the cavern; and it is a technically unfeasible solution because it does not describe how the pressure and temperature in the cavern will reach conditions to make the CO₂ become liquid or enter a supercritical state (critical point) so that it separates from the NG. The temperature in the cavern is mentioned as being between 42 and 44 degrees Celsius (well above the required level of around −10 degrees Celsius) and the pressure at 45 MPa (far above the required level of around 10 MPa), i.e., the conditions in the cavern they make the CO₂ and NG mixture miscible in gaseous form.

Documents EP 2994517 B1 and U.S. Pat. No. 10,024,149 B2 refer to an EOR method, which comprises a first step of injecting into the reservoir a composition of pure CO₂ in a supercritical state or close to the same and a second step of injecting a composition comprising CO₂ and a hydrocarbon in its supercritical state or close to the same. In both steps of injection in the reservoir, the injected fluids have different compositions, viscosities and densities, and the steps occur alternately in the oil reservoir, each for a period of time, from 1 month to 12 months. Therefore, they do not mention any other modality of CCUS, besides the injection of CO₂ into the reservoir, and do not mention the issue of how to minimize the occurrence of a gas breakthrough occurring prematurely in the oil producing well.

The document Final Report: Carbon Life Cycle Analysis of CO₂-EOR for Net Carbon Negative Oil (NCNO) Classification <https://www.osti.gov/servlets/purl/1525864, accessed May 3, 2023> evaluates the operational performance, environmental impact (CO₂ emissions) and mitigation (geological storage of CO₂—CCUS) through four EOR scenarios, from the beginning to the end of the operations, via injection: 1. continuous CO₂ (CGI); 2. alternating CO₂ and brine (6 months each), called WAG; 3. continuous CO₂ with the addition of peripheral water (along the oil-water contact), called WCI; and 4. Hybrid (WAG+WCI). The analysis is carried out using the Dynamic Carbon Life Cycle Analysis (d-LCA) concept, “CO₂-EOR carbon life cycle analysis for Net Negative Carbon Rating”, according to ISO 14044:2006.

Specifically, the study aims at evaluating whether enhanced oil recovery with carbon dioxide (EOR-CO₂) constitutes a valid alternative for reducing greenhouse gases (GHG). That is, if the total volume of CO₂ injected and stored in the reservoir to produce the incremental oil is greater than the CO₂ emitted throughout the entire CO₂-EOR process, including the capture facility, the EOR site, the refining and burning of the final product, the difference between these two variables being called Net Carbon Negative Oil (NCNO) or “Net Negative Carbon Rating”.

In the four analyzed EOR-CO₂ scenarios, the energy expenditure (electricity and natural gas) of separating the gases produced for CO₂ to be reinjected was considered, through four types of gas separation technology: (1) fractionation, (2) refrigeration, (3) Ryan-Holmes and (4) membrane. All evaluated CO₂-EOR scenarios start operating with a negative carbon footprint and, a few years later, start operating with a positive carbon footprint. That is, the incremental oil produced was not net carbon negative (NCNO) during the useful life of the field evaluated at 25 years. Therefore, more CO₂ is emitted than stored by the EOR-CO₂ process. Accordingly, GHG emissions are not reduced, thereby compromising oil production goals. In all cases, the CO₂ storage reached a maximum (at about 4 years), then decreased over time and became positive, and the maximum point was reached when the recycled CO₂ (returned to the surface) exceeded the CO₂ injection rate.

However, it is worth mentioning that WAG injection was identified as the strategy with the greatest potential to optimize the EOR-CO₂ due to the best compromise between operational and environmental performance, as it produced more oil than WCI and produced 80% of the oil produced by CGI with only 58% of the CO₂ injected. And it had a better indicator of EOR-CO₂ efficiency, due to the smaller volume of CO₂ that needed to be injected and emitted to produce a barrel of oil. Furthermore, it remained with a negative carbon balance for 13 to 18 years (=emission-storage), that is, the oil produced is net carbon negative and the CCUS system operated with a negative carbon footprint during this period. However, in an oil field with a useful life of between 25 and 30 years, for about half of the years the EOR process ends up emitting more CO₂ than is stored, that is, the produced incremental oil will not be net carbon negative (NCNO) during the useful life of the field. Therefore, more CO₂ is emitted than stored by the EOR-CO₂ process. Accordingly, the GHG emissions are not reduced, thereby compromising oil production goals. Furthermore, they do not mention any other modality of CCUS, besides the injection of CO₂ into the reservoir, and do not mention the issue of how to minimize the occurrence of a gas breakthrough prematurely in the oil producing well.

And, in addition to the previous document by the same author, there is the document Environmental and Operational Performance of CO₂-EOR as a CCUS Technology: A Cranfield Example with Dynamic LCA Considerations (Núñez-López et al, Energies 2019, 12, 488), in which the authors add a possibility of environmental improvement in the already-analyzed cases, assuming a stacked storage scheme for the EOR process. Basically, when the NCNO reaches a negative maximum (CO₂ returned to the surface exceeds the CO₂ injection rate) during the life of a field, the excess CO₂ begins to be injected directly into an underlying or associated saline aquifer for absorption and storage of CO₂ in the long term. As a result, the negative carbon balance occurs for a longer period of time (19 years in the WAG case), that is, a greater volume of oil is produced under a negative carbon footprint condition.

However, the EOR-CO₂ process is still not valid for reducing greenhouse gases (GHG). In other words, the total volume of CO₂ injected and stored in the reservoir and in the saline aquifer to produce the incremental oil is less than the CO₂ emitted throughout the entire CO₂-EOR process during the useful life of the field. As a result, the project has a positive carbon footprint, that is, the incremental oil produced was not net carbon negative (NCNO) during the useful life of the field. Therefore, more CO₂ is emitted than stored by the EOR-CO₂ process; accordingly, the GHG emissions are not reduced, thereby compromising the oil production goals.

Furthermore, such a proposal has some conceptual errors, for example, a shallow saline aquifer (less depth than the reservoir) has the capacity to receive a pressure and a CO₂ injection flow rate much lower than the excess CO₂ returned to the surface in the EOR process; accordingly, the NCNO will occur for a much shorter period of time, and waiting for the NCNO to reach its maximum can cause an early breakthrough of CO₂ in the producing well and even the loss of the producing well.

The document A Thermodynamic Model for Carbon Dioxide Storage in Underground Salt Caverns (Zhang et al, Energies 2022, 15, 4299) investigated the feasibility of storing CO₂ in a cavern in salt rock by means of a comparative study on thermodynamic behavior, specially the Joule-Thomson effect, in the processes of injection and withdrawing of CH₄ and CO₂ in a cavern in salt rock, in which it is ascertained that, under the same conditions in a cavern that once stored CH₄, there can be stored around 2.3 times the volume of CO₂ compared to the one of CH₄; however, it exhibited a greater variation in temperature. With these results, the authors intend to continue the research, but with a focus on using CO₂ as a base gas in a CH₄ storage cavern and thereby reducing CAPEX, in addition to promoting CCUS. Given the difficulties present in the abovementioned state of the art, regarding the simultaneous capture, utilization and storage of CO₂, there is a need to develop a technology capable of safely and efficiently carrying out such operations in an integrated and simultaneous manner with the oil recovery and production.

Thus, differently from the state of the art, the present invention aims at providing the use and storage of CO₂ via caverns in salt rocks, as a geological buffer, which operates in a cyclical, simultaneous and integrated way with the production and recovery process of hydrocarbons. Furthermore, it also provides operational flexibility in decisions regarding the types of capture, utilization and storage of CO₂ that can be carried out. Notwithstanding, the present invention makes it possible to inject the right amount of CO₂ into the reservoir to generate an increase in oil production, maximize the oil recovery factor and extend the useful life of the field, as well as enabling a reduction in greenhouse gases, for producing a Net Carbon Negative Oil (NCNO) throughout the useful life of the oil field.

### SUMMARY OF THE INVENTION

The present invention refers to a method and system for carrying out different simultaneous modalities (operational flexibility) of capture, utilization and storage of CO₂ (CCUS) through thermomechanical cycling in a cavern in salt rock with water. This occurs, in an integrated way, through the use of CSR, which acts as a geological buffer or control volume for CO₂, which operates in a cyclical (filling or emptying), intermediate or precursor way, to simultaneously enable the other different modalities of CCUS, which work under different pressure and flow rate conditions. This can increase the recovery and production of hydrocarbons, as well as promoting an increase in CCUS.

The use of a cavern in salt rock (CSR) for the exclusive storage of CO₂ is one of the possibilities within the concepts of capture, utilization and storage of CO₂ (CCUS), with the aim of reducing the emission of Greenhouse Gases (GHG) into the atmosphere.

However, the construction of the CSR exclusively and definitively for the storage (disposal) of CO₂ (CCUS) would not be technically and economically interesting, as the salt rock would only be subjected to filling (half a cycle) and would then be definitively abandoned. In other words, the full potential of the CSR would not be used, which allows several filling and emptying cycles with high injection and withdrawal rates in a single day, vastly superior when compared to a depleted reservoir or aquifer in terms of using the CSR as a means of production and storage.

Specifically, regarding the economic aspect, because the CSR is a structure to be built for the storage of CO₂, on the one hand it makes its CAPEX (capital investment-Capital Expenditure) high in relation to other solutions storage, such as in a saline aquifer or in a depleted reservoir (both widely available); so, to date, there is no CSR built specifically for this purpose, despite the existence of hundreds of CSRs, used to store different types of products. But, on the other hand, regarding the technical aspect, as it was specifically designed for this purpose, it is naturally a technology that offers greater safety and effectiveness over time, in addition to enabling a high storage rate (Xie, L.-Z & Zhou, Hongwei & Xie, Heping. Research advancement of CO₂ storage in rock salt caverns. Yantu Lixue/Rock and Soil Mechanics. 5 30. 3324-3330, 2009) in which CO₂ can remain in a liquid state.

Therefore, in the conception of the invention, the CSR is subjected to tens to thousands of filling and emptying cycles during its useful life, instead of being conventionally subjected to only ½ cycle.

Furthermore, it is worth mentioning that when combining the use of CSR with oil recovery processes in the reservoir, for example, in the EOR-WAG process, the same is allowed to store the CO₂ coming from the process plant of a Stationary Production Unit (SPU) or directly from a production well (via subsea separation) during periods in which water (brine) is flowed from the injection well, instead of CO₂ being released into the atmosphere, with the CO₂ partially flowed later into the injection well and, even so, continue to store the CO₂ coming from the production of the hydrocarbon. And, it is also possible to use the CSR as a precursor means (geological buffer or temporary or intermediate control volume) for other modalities of CO₂ storage (such as in a depleted reservoir, in an aquifer or porous/permeable rock).

In this way, the method developed in the present invention makes it possible to perform oil recovery via EOR-CO₂ and/or EOR-WAG (alternating water-gas injection) simultaneously and integrated with the capture/storage (CCUS) of CO₂ in the CSR, in which the CSR simultaneously acts as a geological buffer or CO₂ control volume, promoting hydrocarbon recovery (EOR) and CCUS.

The proposed method presents a condition that surpasses the state of the art by making the CSR work as a precursor and enabler of other modalities of geological storage of CO₂, due to the fact that the CSR works as a geological buffer or volume of temporary or intermediate control. This enables the enhanced oil recovery (EOR) simultaneously (integrated) with Capture, Utilization and Storage of CO₂ (CCUS), thus providing better results than the way described in the state of the art, where each technology is individually operated. Therefore, the margin of incremental oil produced using CO₂ injection together with the relative value of the reduction in CO₂ emissions makes certain oil fields economically viable and can increase profitability in the revitalization of certain fields by maximizing the recovery factor.

### BRIEF DESCRIPTION OF THE FIGURES

The present invention will be described in more detail below, with reference to the attached figures that, in a schematic way and not limiting the inventive scope, represent examples of its embodiment.

FIG. 1 schematically illustrates the state of the art of an EOR process, with its effects on the production of equivalent oil, in the presence of CO₂ in a reservoir and NCNO during the useful life of an oil field.

FIG. 2 schematically illustrates an offshore cavern in salt rock as a precursor means and of operational flexibility of other modalities of capture, utilization and storage of CO₂ in deep water depth (LDA) of the present invention.

FIG. 3 schematically illustrates a variation of FIG. 1, where, instead of a SPU, a fixed shallow LDA platform of the present invention is used.

FIG. 4 schematically illustrates the CO₂ pressure and flow rate curves over time in a CSR, in an injection well (EOR-WAG-CO₂), in a depleted reservoir, in an aquifer and in a porous/permeable/CO₂-reactive rock.

FIG. 5 schematically illustrates the stored volume of CO₂ over a time interval in the CSR, in the EOR-WAG-CO₂ injection well, in the depleted reservoir, in the aquifer and in the porous/permeable/CO₂-reactive rock.

FIG. 6 illustrates the collection of CO₂ in different regions and its prior storage in a CSR, to provide operational flexibility, before being distributed across other CCUS modes.

FIG. 7 graphically illustrates the effects of the present invention on the production of equivalent oil, in the presence of CO₂ in a reservoir and NCNO during the useful life of an oil field.

The numerical references in said Figures are listed below:
(01) Oil reservoir;
(02) Production well;
(03) Hydrocarbon flow from the producing well to subsea equipment (manifold or pump or compressor or subsea separator);
(04) Manifold or pump or compressor or subsea separator (water-oil or gas-liquid);
(05) Flow of hydrocarbon production to the Stationary Production Unit (SPU);
(06) SPU;
(07) Injection of processed greenhouse gases, such as CO₂, into an access well leading to a cavern in salt rock (CSR);
(08) CSR access well;
(09) CSR;
(10) Salt rock layer;
(11) Rigid or flexible piping positioned close to the bottom/base of the CSR for fluid input/output (CO₂);
(12) CO₂ inlet into the CSR from 04;
(13) Rigid or flexible piping positioned close to the top of the CSR for fluid input/output (CO₂ and/or natural gas);
(14) Manifold or pump or compressor or subsea separator installed downstream of the CSR;
(15) Subsea valve;
(16) CO₂ flow from/to injection well;
(17) CO₂ injection well;
(18) CO₂ injection into the oil reservoir for enhanced recovery;
(19) CO₂ flow for three CO₂ capture options;
(20) CO₂ flow to depleted hydrocarbon reservoir;
(21) CO₂ injection well for depleted hydrocarbon reservoir;
(22) Depleted hydrocarbon reservoir;
(23) CO₂ flow into the aquifer;
(24) CO₂ injection well for aquifer;
(25) Aquifer;
(26) CO₂ flow into porous or permeable or CO₂-reactive rock;
(27) CO₂ injection well for porous or permeable or CO₂-reactive rock;
(28) Porous or permeable or CO₂-reactive rock;
(29) Fixed platform in shallow water depth (LDA);
(30) Processing, treatment and re-pumping/recompression module (separators, filters, pumps, compressors, etc.);
(31)-(34) Different remote fields/locations that generate greenhouse gases;
(40) Collection and flow of greenhouse gases produced in remote fields.

### DETAILED DESCRIPTION OF THE INVENTION

The present invention refers to a method and system for carrying out different simultaneous modalities of capture, utilization and storage of CO₂ (CCUS) through thermomechanical cycling in a cavern in salt rock with water, which substantially increases the operational flexibility and generates greater economic and environmental performance.

There follows below a detailed description of a preferred embodiment of the present invention, which is exemplary and in no way limiting. Nevertheless, it will be clear to a technician skilled on the subject, from reading this description, possible additional embodiments of the present invention further comprised by the essential and optional features below.

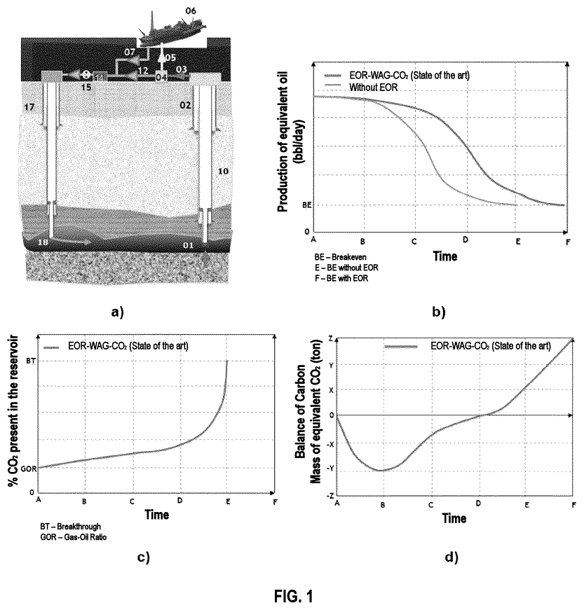

FIG. 1a illustrates the state of the art of an EOR process. The hydrocarbon and other fluids produced in a reservoir (01) through a producing well (02) are flowed (03) to a manifold or pump or compressor or subsea separator (water-oil or gas-liquid) (04), and then are flowed (05) to a Stationary Production Unit (SPU) (06) to be processed by means of physical and/or chemical processes, in order to separate the fluids produced into oil, gas and water. The excess gases produced, such as methane, ethane, butane, CO₂, etc., are released/burned in the SPU flare, when it is an emergency, to reduce the risk of explosions, but this generates greenhouse gases. And it is worth mentioning that there are environmental limits on the emission of greenhouse gases by the SPU; therefore, in a field with a high gas-oil ratio (GOR) and/or high CO₂ content, all CO₂ produced and other gases cannot be launched via flare (burned). This is where the enhanced oil recovery (EOR) process comes into action, which is an economic and environmental alternative to burning the gases produced and even the produced CO₂ with the hydrocarbon, by flowing the same (07 and 12) in an injection well (17) in the reservoir (18) by means of a subsea pump or compressor (14), or even coming directly from the Floating Unit (06).

FIG. 1b illustrates the economic aspect of the EOR process in the state of the art in relation to the condition without EOR. Over time (A-F) the EOR process allows for a greater volume of oil production, as well as a longer production time (F), until reaching Breakeven (BE), which is the equilibrium price of oil, that is, it is the price of oil that makes it worthwhile for an oil producer to produce and sell oil.

FIG. 1c illustrates an effect of the EOR process on the state of the art, in which the percentage of injected gases (CO₂, natural gas, etc.) increases the Gas-Oil Ratio (GOR) present in the reservoir, which can lead to a premature (in time E) Breakthrough (BT) of gas in the producing well and thus losing the same.

FIG. 1d illustrates another effect of the EOR process in the state of the art, in which the negative carbon balance (NCNO) ceases to occur after a certain time (D); with this, in the incremental oil produced during the useful life of the field more CO₂ is emitted than stored; accordingly, GHG emissions are not reduced, thereby compromising the oil production goals. It is worth mentioning the following notable times: (A) start of the EOR process with the injection of gases (CO₂, natural gas, etc.) into the CO₂ reservoir; (B) is the moment of maximum Negative Carbon Balance (NCNO); it stores more CO₂ than it generates CO₂; (D) is the moment when Net Carbon Negative Oil (NCNO) stops occurring; (A-D) is the time period in which NCNO occurs; (D-F) is the period of positive carbon footprint; (F) is the useful life of the field, in which more CO₂ was generated than CO₂ was stored.

Specifically, in the EOR-WAG-CO₂ process in the state of the art, additional problems are generated. During the period in which there is no injection of CO₂ into the reservoir (water is injected) through the EOR-WAG-CO₂ process, this becomes a major problem, which can currently be solved in two ways: either reducing oil production or injecting all CO₂ and other associated gases into the reservoir, instead of carrying out EOR-WAG-CO₂.

Due to the significant and immediate loss of revenue, for the first option, what ends up happening is to continuously re-inject all the gases produced into the reservoir, but this option in the medium and long term is harmful to the reservoir due to the early breakthrough of the injected gas, and the increase in the Gas-Oil Ratio (GOR) in producing wells, which results in a future reduction in oil production due to limitations in the gas processing capacity at the SPU. In other words, the second option only postpones the occurrence of the first one.

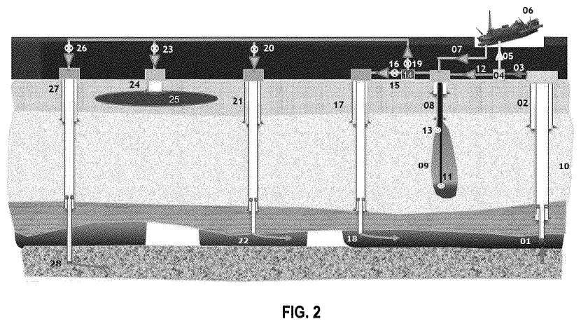

FIG. 2 schematically illustrates the system of the present invention, which is a solution to the aforementioned problems in the state of the art. An alternative to burning the produced gases and, even the excess CO₂ produced with the hydrocarbon, is to flow the same (07) into an access well (08) leading to a cavern in salt rock (CSR) (09), built using the method of leaching, in a layer of salt rock (10), through the use of a rigid or flexible pipeline positioned close to the bottom/base of the CSR for the input/output of fluids (CO₂ and other gases) (11). In the case of using subsea separators (04), the fluids can be flowed (12) directly into the CSR (09) without passing through the SPU (06).

Due to the intrinsic characteristics already described about the salt rock, the CSR (09) can accumulate significant volumes of fluids at high pressures and high flow rates, with these last two parameters making it a precursor medium as a control volume, in order to enable different means of CCUS. For example, by using rigid or flexible piping positioned at the top of the CSR for the input/output of fluids (CO₂ and other gases) (13), the fluids are flowed through a subsea pump or compressor (14), installed at downstream of the CSR, passing through a valve (15) and thus flowing fluids (CO₂ and other gases) (16) into an injection well (17), to promote enhanced oil recovery (18), for example, by the WAG method.

Another modality of CCUS, but with a focus on definitive storage, would be to flow the fluids (CO₂ and other gases) (19) to other injection wells, for example, through an injection well (20), in an access well (21) to a depleted reservoir (22), and/or to another injection well (23) in an access well (24) to an aquifer (25), and/or to another injection well (26) in an access well (27) to a porous/permeable rock that is reactive or not to fluids (28).

The CSR (09) is used as an intermediate CO₂ storage condition or precursor to other CO₂ storage modalities, for, due to its intrinsic characteristics, as already mentioned, it can have several filling and emptying cycles with high rates of injection and withdrawing of fluids (brine and gases) daily and, operate at high pressures, much higher when compared to other modes of CO₂ storage; for example, at flow rates of 8 million Nm³ of gas, which is the limit of the subsea Christmas tree, in addition to accumulating significant volumes of CO₂ in a supercritical state and operating at pressures of up to 90% of the burial gradient at the ceiling of the CSR.

It is worth mentioning that thermomechanical cycling occurs in the CSR, because, when a gas is compressed, due to the conservation of energy (1^{st} Law of Thermodynamics) there is an increase in temperature as a natural consequence, and when a gas expands, due to the effect Joule-Thomson, there is a reduction in temperature, which occurs during the filling and emptying processes of the CSR, respectively.

The geological storage of CO₂ in a porous-permeable rock (28) (in the form of CO₂ adsorption on the mineral wall or in the pore throat present in the rock) or in an aquifer or depleted hydrocarbon reservoir (22) (in the form of CO₂ dissolution in water or oil or gas) or in a CO₂ reactive rock (28) (in the solid form of CO₂ due to chemical reactions with the reactive rock forming a mineral precipitation of CO₂) have limitations of flow rates and CO₂ injection pressures, which may be below the conditions generated in a SPU (06) and up to two orders of magnitude of flow rate and pressure when compared to the use of CSR. In addition, there is the time factor in which different types of CO₂ trapping mechanisms take time to occur.

However, in relation to CO₂ storage in CSR (09), such mechanisms (residual, solubility and mineral) are more significant in terms of safety over the years (IPCC, 2005. IPCC Special Report on Carbon Dioxide Capture and Storage. Prepared by Working Group III of the Intergovernmental Panel on Climate Change [METZ, B., O. DAVIDSON, H. C. de CONINCK, M. LOOS, and L. A. MEYER (eds.)]. Cambridge University Press, Cambridge, United Kingdom and New York, NY, USA, 2005, 442 p.).

With the presence of a porous or permeable or CO₂-reactive rock (28) or an aquifer or a depleted hydrocarbon reservoir (22) close to a SPU (06), the CO₂ flow (19) from the CSR (09) for the porous or permeable or CO₂ reactive rock (28) or for the aquifer (25) or the depleted hydrocarbon reservoir (22) could occur under the pressure and flow rate conditions that such structures and mechanisms could withstand for storage of the CO₂, thus increasing the volume of stored CO₂ and the process safety.

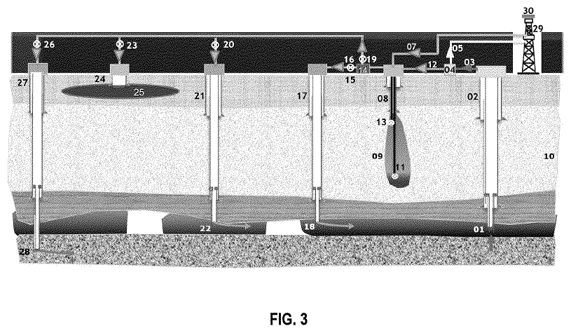

It is worth mentioning that, with the present invention, it is possible to inject into the reservoir (17) the exact amount (volume at a certain pressure) of gases (CO₂, natural gas, etc.) that will maximize the oil production, as well as maintain the NCNO during the useful life of the field, thus producing a better economic and environmental performance than the state of the art. A variation of the system described in FIG. 2 is described in FIG. 3, in which, instead of a SPU (06), a fixed platform (29) in shallow LDA is used, which has a processing, treatment, re-pumping/recompression module (separators, filters, pumps, compressors, etc.) (30).

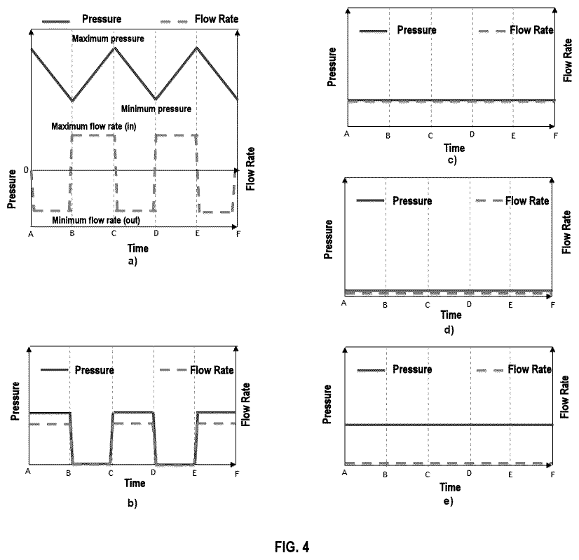

With the present invention, in a field scenario with high GOR and high CO₂ content, instead of injecting all the CO₂ and other associated gases into the reservoir (18), EOR-WAG-CO₂ can be performed, via temporary storage of excess gases in the CSR (9), as shown in FIG. 4a, to be used later and during the injection of CO₂ in the different CCUS modalities (FIGS. 4b to 4e).

FIG. 4 qualitatively presents the pressure and flow rate of CO₂ over time in the different CCUS modalities, in FIG. 4a in the CSR (9), in FIG. 4b in the EOR-WAG-CO₂ injection well (18), in FIG. 4c in depleted reservoir (22), in FIG. 4d in aquifer (25) and in FIG. 4e in porous/permeable/CO₂-reactive rock (28).

As a reference, the limits of the minimum and maximum pressure in the CSR (FIG. 4a) are equivalent to between 20 and 90% of the burial gradient at the depth of the CSR ceiling (specific weight of the rock×depth of the cavern ceiling). And the maximum flow rate in the CSR is 8 million Nm³ of gas, which is a limit for the subsea Christmas tree installed in the CSR access well (8).

FIG. 4a shows the pressure and flow rate of CO₂ over time in the CSR (9) from the moment the CSR is already full of CO₂, at a pressure of 90% of the burial gradient in the top of the CSR, time A. From then on, the CSR empties (negative flow rate) by up to 8 million Nm³ of gas, which occurs until the pressure in the CSR reaches 20% of the burial gradient, time B, wherein the volume of CO₂ that leaves the CSR is injected into other modalities of CO₂ capture and storage. From then on, the filling of the CSR (positive flow rate) with up to 8 million Nm³ of gas begins, which occurs until the pressure in the CSR reaches 90% of the burial gradient, time C. This demonstrates a cycle complete of emptying and filling of the CSR, which occurs cyclically and continuously over time.

In FIG. 4b there is the pressure and flow rate of CO₂ over time, for example, in an EOR-WAG-CO₂ injection well (18), from the moment CO₂ is injected at a pressure and flow rate constant, Time A to Time B, in the order of up to 50% of that which occurs in the CSR, as it depends on the intrinsic characteristics of the reservoir rock and the established drainage network. At time B, the water injection period begins, which occurs until time C, so the flow rate and CO₂ pressure are zero. With this, a complete EOR-WAG-CO₂ cycle (alternating WAG water-gas injection) is demonstrated in an injection well, which occurs cyclically and continuously over time. It is worth mentioning the synchronism that occurs with the CSR and the EOR-WAG-CO₂ injection well; when the CSR is being emptied of CO₂, CO₂ is being injected into the injection well, time interval A-B, and when the CSR is being filled with CO₂, no CO₂ is being injected into the injection well.

In FIG. 4c, there is the pressure and flow rate of CO₂ over time in a depleted reservoir (22), which can occur at a constant flow rate and pressure over time, in the order of up to 50% of that which occurs in CSR, as it depends on the intrinsic characteristics of the depleted reservoir.

In FIG. 4d, there is the pressure and flow rate of CO₂ over time in the aquifer (25) which can occur at a constant flow and pressure over time, in the order of up to 30% of that which occurs in the CSR, as it depends on the depth at which the aquifer is located and the characteristics of the rock that traps the aquifer.

In FIG. 4e, there is the pressure and flow rate of CO₂ over time in the porous/permeable/CO₂-reactive rock (28), which can occur at a constant flow rate over time, in the order of up to 10% of that which occurs in the CSR, and at a constant pressure throughout, in the order of up to 100% of that which occurs in the CSR, as it depends on the intrinsic characteristics of the rock that will receive the CO₂.

Table 1 qualitatively summarizes the pressure, flow, stored volume and type of process that can occur in the CSR and in each of the other CCUS modes (injection well, depleted reservoir, aquifer, CO₂-reactive rock), which were illustrated and quantified (pressure and flow rate) by using FIGS. 4a-4e described previously.

TABLE 1
Main differences (qualitatively) between
the different CCUS modalities.

| | | EOR | | | CO₂- |
|---|---|---|---|---|---|
| | | Injection | Depleted | | Reactive |
| | CSR | well | Reservoir | Aquifer | Rock |
| Pressure | High | Medium | Medium | Low | Medium |
| Flow Rate | High | Medium | Medium | Low | Low |
| Stored | Low | High | High | High | Medium |
| Volume | | | | | |
| Process | Cyclic | Intermittent | Contin- | Contin- | Contin- |
| | | | uous | uous | uous |

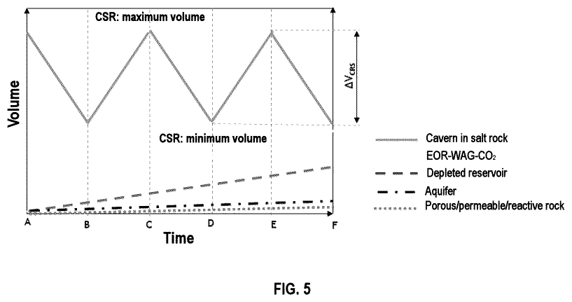

FIG. 5 schematically presents the stored volume of CO₂ over a time interval (A-F) in the different CCUS modalities, in the CSR (9), in an EOR-WAG-CO₂ injection well (18), in the depleted reservoir (22), in the aquifer (25) and in the porous/permeable/CO₂-reactive rock (28). It is worth mentioning that, in the injection well, the CO₂ injection process can occur intermittently (sometimes yes, sometimes no) and continuously (linear curve) in the depleted reservoir, in the aquifer and in the reactive rock, while in the CSR it occurs cyclically over time. It is worth mentioning that, in an oil field, which may have dozens of injection wells and dozens of production wells, for example, in an EOR-WAG-CO₂ scenario, in the time interval that water is injected into some injection wells and, in the other injection wells, it is injected CO₂ and other gases, with the present invention it is possible to inject the right amount of gases into the reservoir to maximize oil production and maximize CO₂ storage in different CCUS modalities; whereas in the state of the art, in injection wells for CO₂ and other gases, more than is necessary is injected, thereby producing the deleterious effects already mentioned (increase in GOR, breakthrough, reduction in NCNO, reduction in volume of produced oil, etc.).

The maximum pressure/volume and the minimum pressure/volume in the CSR, that is, the volume variation in the CSR (AVCSR), which occurs cyclically to enable different CCUS modalities simultaneously and with the smallest possible size of CSR, define the moments of injection or withdrawal of CO₂ in the CSR, while the volumes of CO₂ in the different modes increase progressively over time, there is an observation for the EOR-WAG-COS, which remains with a constant volume (without CO₂ injection) during the period of water injection in the reservoir.

During the cavern emptying period (interval from maximum to minimum volume), the control of the injected volume for each of the CCUS modalities is defined based on equation 1:

$${V}_{CO 2\_ generated} + {V}_{out \_ CSR} = {V}_{in \_ EOR} + {V}_{in \_ DR} + {V}_{in \_ Aq} + {V}_{in \_ PPR} \qquad ( 1 )$$

Wherein:
V_{CO2_generated}: volume of gases produced in the field;
V_{out_CSR}: volume of gases withdrawn from the CSR (9) for other CCUS modalities;
V_{in_EOR}: volume of CO₂ injected into EOR-WAG-CO₂ (18);
V_{in_DR}: volume of CO₂ injected into depleted reservoir (22);
V_{in_Aq}: volume of CO₂ injected into aquifer (25);
V_{in_PPR}: volume of CO₂ injected into porous/permeable/CO₂-reactive rock (28).

And, during the cavern filling period (interval from minimum to maximum volume), the control of the injected volume for each of the CCUS modalities is defined based on equation 2:

$${V}_{CO 2\_ generated} = {V}_{out \_ CSR} + {V}_{in \_ EOR} + {V}_{in \_ DR} + {V}_{in \_ Aq} + {V}_{in \_ PPR} \qquad ( 2 )$$

Wherein:
V_{in_CSR}: volume of gases injected into the CSR (9).

The control of the volumes injected into the EOR-WAG-CO₂ injection well (18), the depleted reservoir (22), the aquifer (25) and the porous/permeable/CO₂-reactive rock (28) can be made by using of valves 16, 19 and 20, 19 and 23 and 19 and 26, respectively (FIGS. 2 and 3), remotely activated at the SPU.

As for the volume variation in the CSR (AVCSR), also called Working Gas (V_{working}=Vₘₐₓ−Vₘᵢₙ), it can be defined from equation (3), based on the time interval defined for the injection of CO₂ into the reservoir and at the flow rate defined for each modality (volume=time×flow rate):

$$Δ {V}_{CSR} = {V}_{in \_ EOR} + {V}_{in \_ DR} + {V}_{in \_ Aq} + {V}_{in \_ PPR} \qquad ( 3 )$$

As for the maximum and minimum pressures in the CSR, they can be defined based on the depth at which the last casing shoe is located in the CSR access well, in which at a shallow Water Depth (LDA) (0 to 300 m) can be between 400 and 1000 m deep and, in deep LDA, 2500 to 4500 m deep, with the maximum pressure limited to 90% of the burial gradient and the minimum pressure limited to 20% of the burial gradient (0.7 to 1.0 psi/ft (15.834 to 22.621 kPa/m)) at the CSR ceiling depth.

It is worth mentioning that the maximum volume of CO₂ (Vₘₐₓ) in the CSR, equation 4, depends on the geometric volume of the CSR (V_{geom}), the maximum pressure inside the CSR (pₘₐₓ) and the CO₂ compressibility factor (zₘₐₓ) in the pressure (pₘₐₓ) and temperature (T_{cavern}) conditions within the CSR and CO₂ conditions in the Normal Temperature and Pressure Conditions (NTP). And, the pressure and temperature conditions depend on the depth at which the CSR is located.

$${V}_{max} = \frac{{Z}_{NTP} {T}_{NTP}}{{p}_{NTP}} \frac{{p}_{max}}{{z}_{max} {T}_{cavern}} {V}_{geom} \qquad ( 4 )$$

And the minimum volume of CO₂ (Vₘᵢₙ) in the CSR, equation 5, also called Cushing Gas (V_{Cushing}=Vₘₐₓ−V_{working}), depends on the geometric volume of the CSR (V_{geom}), the minimum pressure inside the CSR (pₘᵢₙ), the CO₂ compressibility factor (zₘᵢₙ) under the pressure (pₘᵢₙ) and temperature (T_{cavern}) conditions in which it is located inside the CSR and the CO₂ conditions under the Normal Temperature and Pressure Conditions (NTP). And the pressure and temperature conditions depend on the depth at which the CSR is located.

$${V}_{cushing} = \frac{{Z}_{NTP} {T}_{NTP}}{{p}_{NTP}} \frac{{p}_{min}}{{z}_{min} {T}_{cavern}} {V}_{geom} \qquad ( 5 )$$

It is worth mentioning that the geometric volume of the CSR (V_{geom}), which can vary from hundreds of cubic meters to billions of cubic meters, depends on the thickness of the salt rock layer existing in the location defined to construct the same, as well as the volumes and CCUS modalities to be applied.

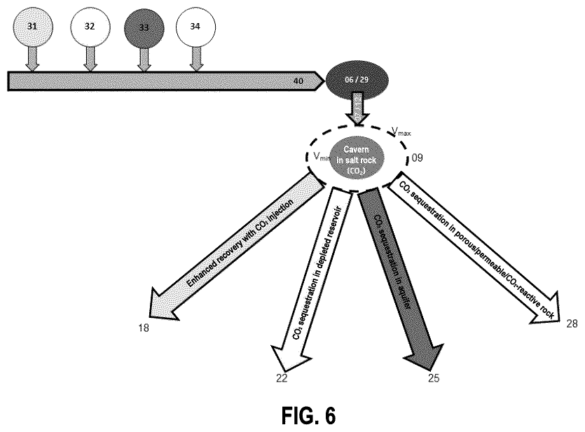

FIG. 6 exemplifies the present invention, in which CO₂ can be brought from different fields/different regions (31-34) through a gas pipeline, for example (40), and is stored cyclically (between a maximum and minimum volume) in a CSR (9) and, from there, it is distributed across the different CCUS modes, in the CSR (9), in the EOR-WAG-CO₂ injection well (18), in the depleted reservoir (22), in the aquifer (25) and in porous/permeable/CO₂-reactive rock (28), forming a CCUS hub.

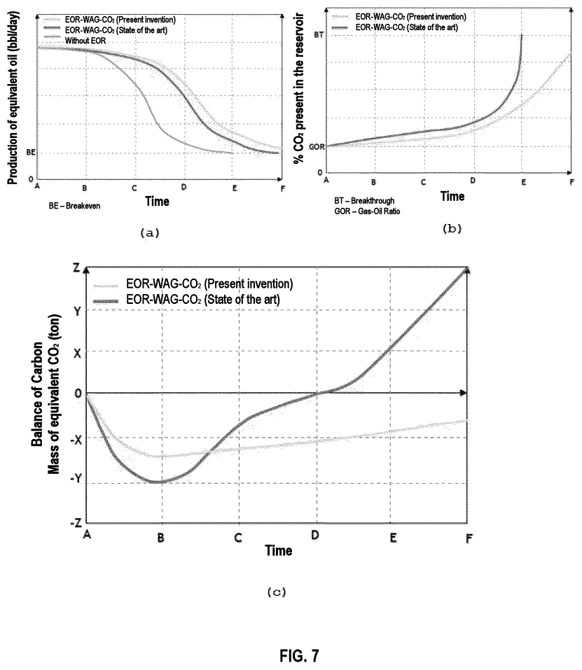

FIG. 7 illustrates the main advantages of the present invention based on the state of the art in the EOR process. FIG. 7a shows the increase in oil equivalent production as well as the extension of BE beyond time (F). FIG. 7b shows the evolution of the percentage of gases in the reservoir, which during the useful life of the field (F) does not lead to BT. FIG. 7c shows that NCNO remains throughout the useful life of an oil field. Such results are possible by injecting the ideal quantity of gases into the reservoir, with the surplus being managed by cycling CO₂ and other gases in the CSR, which distributes the same to the other CCUS modes.

Accordingly, the present invention refers to a method and system that is a precursor and enabler of different simultaneous and integrated modalities of capture, utilization and storage of CO₂ (CCUS), due to the fact that it comprises the thermomechanical cycling of CO₂ in a cavern in salt rock (CSR), wherein the CSR acts as a geological buffer or control volume for COS, which operates cyclically (under high flow rates and pressures), sometimes filling to accumulate excess CO₂ that should not be flowed into injection wells of CO₂ (to maximize field recovery), sometimes emptying to flow the CO to other CCUS modalities (such as depleted reservoir, aquifer, porous/permeable rock), thus always maintaining the optimal CO₂ flow rate (in the exact amount of volume at a certain pressure) in CO₂ injection wells to maximize hydrocarbon production from the oil field.

This generates an asset of robustness in operational flexibility. For example, at times when CO₂ cannot be stored by one mode, whether due to maintenance shutdown (scheduled or not), CO₂ can flow through the other modes. Thus, there is an increase in the operational availability time and the general reliability of the system, in an integrated way, the recovery and production of hydrocarbons, as well as the promotion of CCUS simultaneously under different modalities, and it further creates a robust infrastructure to enable the reduction of the Greenhouse Gas Index (GEEI) and future monetization with carbon trading.

Furthermore, the method described in the present invention makes it possible to increase the margin of incremental oil produced using CO₂ injection together with the relative value of the CO₂ emission reduction to make certain oil fields become economically viable, and can increase profitability in the revitalization of certain fields by maximizing the recovery factor. And the process makes it possible for the EOR process to be valid as a means of reducing greenhouse gases (negative carbon footprint), by producing incremental oil with NCNO throughout the entire useful life of the oil field.

Thus, the method described presents better results than the way described in the state of the art, where each CCUS technology is individually operated. In this way, the method developed in the present invention makes it possible to perform oil recovery (EOR), especially in fields with high GOR and CO₂ content, by alternating WAG water-gas (brine-CO₂) injection, simultaneously (integrated) with CO₂ capture/storage (CCUS) in the CSR, in which the CSR simultaneously acts as a subsea geological buffer (lung) for alternating water-gas injection (brine-CO₂) promoting hydrocarbon recovery (EOR) and the CCUS. This generates operational flexibility in the capture, utilization and storage of CO₂, in an integrated way and, therefore, can expand the recovery and production of hydrocarbons, as well as promoting CCUS. Accordingly, it results in a surprising technical effect, generating greater performance simultaneously in both oil production (economic aspect) and environmental (CO₂ sequestration), optimizing the EOR-CO₂ process and the geological storage of CO₂, thus highlighting the technical superiority and the non-deductibility of the present invention, when compared to the state of the art, thus characterizing the novelty and inventive step and having industrial application.

The description given so far of the present process should be considered only as a possible embodiment, and any particular features should be understood as something that was described to facilitate understanding. In this way, they cannot be considered as limiting the invention, which is limited only to the scope of the claims that follow.

What is claimed is:

1. A system for carrying out different simultaneous modalities of capture, utilization and storage of CO₂, comprising the following components:
Oil reservoir;
Production well;
Manifold or pump or compressor or subsea separator (water-oil or gas-liquid);
SPU;
CSR access well;
CSR;
Layer of salt rock;
Rigid or flexible piping positioned close to the bottom/base of the CSR for fluid (CO₂) input/output;
Rigid or flexible piping positioned close to the top of the CSR for input/output of fluids (CO₂) and/or natural gas;
Manifold or pump or compressor or subsea separator installed downstream of the CSR;
Subsea valve;
CO₂ injection well;
CO₂ injection well for depleted hydrocarbon reservoir;
Depleted hydrocarbon reservoir;
CO₂ injection well for aquifer;
Aquifer;
CO₂ injection well for porous or permeable or CO₂-reactive rock; and
Porous or permeable or CO₂-reactive rock.

2. The system according to claim 1, wherein the hydrocarbon flows from the producing well to the manifold.

3. The system according to claim 1, wherein the hydrocarbon production flows from the manifold to the Stationary Production Unit (SPU).

4. The system according to claim 1, wherein the gases processed in the SPU, mainly CO₂, are injected into an access well leading to a cavern in salt rock (CSR).

5. The system according to claim 1, wherein the CO₂ coming from the manifold enters the cavern in salt rock (CSR).

6. The system according to claim 1, wherein the CO₂ coming from the manifold is flowed to the injection well.

7. The system according to claim 1, wherein the CO₂ coming from the injection well is injected into the oil reservoir for enhanced recovery.

8. The system according to claim 1, wherein the CO₂ coming from the manifold is flowed to three CO₂ capture options.

9. The system according to claim 8, wherein the CO₂ flow is to a depleted hydrocarbon reservoir through the injection well.

10. The system according to claim 8, wherein the CO₂ flow is to an aquifer through the injection well.

11. The system according to claim 8, wherein the CO₂ flow is to a porous or permeable or CO₂-reactive rock through the injection well.

12. A method for carrying out different simultaneous modalities of capture, utilization and storage of CO₂, comprising thermomechanical cycling of CO₂ in a cavern in salt rock, wherein the cavern in salt rock acts as a geological buffer or control volume for CO₂, which operates cyclically, sometimes filling to accumulate excess CO₂ that should not be flowed into CO₂ injection wells, sometimes emptying and simultaneously carrying out oil recovery via EOR-CO₂ and/or EOR-WAG simultaneously and integrated with the CO₂ capture/storage in the cavern in salt rock.

13. The method according to claim 12, wherein it enables the recovery and production of hydrocarbons in an integrated manner, as well as promoting the capture, utilization and storage of CO₂ simultaneously under different modalities.

14. The method according to claim 13, wherein the different modalities comprise flowing the CO₂ to a depleted reservoir, aquifer and porous or permeable rock.

15. The method according to claim 12, wherein during the period of emptying the cavern, the control of the injected volume for each of the modalities of capture, utilization and storage of CO₂ is defined based on the equation:
$${V}_{CO 2\_ generated} + {V}_{out \_ CSR} = {V}_{in \_ EOR} + {V}_{in \_ DR} + {V}_{in \_ Aq} + {V}_{in \_ PPR} ,$$
where:
VC_{O2_generated}: volume of gases produced in the field;
V_{out_CSR}: volume of gases withdrawn from the CSR (9) for other CCUS modalities;
V_{in_EOR}: volume of CO₂ injected into EOR-WAG-CO₂ (18);
V_{in_DR}: volume of CO₂ injected into depleted reservoir (22);
V_{in_Aq}: volume of CO₂ injected into aquifer (25);
V_{in_PPR}: volume of CO₂ injected into porous/permeable/CO₂-reactive rock (28).

16. The method according to claim 12, wherein, during the cavern filling period, the control of the injected volume for each of the modalities of capture, utilization and storage of CO₂ is defined based on the equation:
$${V}_{CO 2\_ generated} = {V}_{out \_ CSR} + {V}_{in \_ EOR} + {V}_{in \_ DR} + {V}_{in \_ Aq} + {V}_{in \_ PPR} ,$$
where:
V_{in_CSR}: volume of gases injected into the CSR (9).

17. The method according to claim 12, wherein the volume variation in the cavern in salt rock—ΔV_{CSR}, also called Working Gas (V_{working}=Vₘₐₓ−Vₘᵢₙ), is defined based on the time interval defined for that CO₂ is injected into the reservoir and at the flow rate defined for each modality (volume=time×flow rate), using the equation:
$$Δ {V}_{CSR} = {V}_{in \_ EOR} + {V}_{in \_ DR} + {V}_{in \_ Aq} + {V}_{in \_ PPR} .$$

18. The method according to claim 12, wherein the maximum and minimum pressures in the cavern in salt rock are defined from the depth at which the last casing shoe is located in the access well leading to the cavern in salt rock, wherein in shallow water depths has a depth of 0 to 300 m and in deep water depths of 2,500 to 4,500 m depth.

19. Method according to claim 18, wherein the maximum pressure is limited to 90% of the burial gradient and the minimum pressure is limited to 20% of the burial gradient, from 0.7 to 1.0 psi/ft (15.834 to 22.621 kPa/m), at the depth of the ceiling of the cavern in salt rock.

20. The method according to claim 12, wherein the maximum volume of CO₂ (Vₘₐₓ) in the cavern in salt rock depends on the geometric volume of the cavern in salt rock (V_{geom}), the maximum pressure inside the cavern in salt rock (pₘₐₓ), and the CO₂ compressibility factor (zₘₐₓ) in the conditions of pressure (pₘₐₓ) and temperature (T_{cavern}) in which it is located inside the cavern in salt rock and the CO₂ conditions in the Normal Temperature and Pressure Conditions, wherein the pressure and temperature conditions depend on the depth at which the CSR is located, according to the equation:
$${V}_{max} = \frac{{Z}_{NTP} {T}_{NTP}}{{p}_{NTP}} \frac{{p}_{max}}{{z}_{max} {T}_{cavern}} {V}_{geom} .$$

21. The method according to claim 12, wherein the minimum volume of CO₂ (Vₘᵢₙ) in the cavern in salt rock depends on the geometric volume of the cavern in salt rock (V_{geom}), the minimum pressure inside the cavern in salt rock (pₘᵢₙ), the CO₂ compressibility factor (zₘᵢₙ) in the conditions of pressure (pₘᵢₙ) and temperature (T_{cavern}) in which it is located inside the cavern in salt rock and the CO₂ conditions in the Normal Temperature and Pressure Conditions, and the conditions pressure and temperature depend on the depth at which the cavern in salt rock is located, through the equation:
$${V}_{cushing} = \frac{{Z}_{NTP} {T}_{NTP}}{{p}_{NTP}} \frac{{p}_{min}}{{z}_{min} {T}_{cavern}} {V}_{geom} .$$
